(19) United States
(12) Patent Application Publication
(10) Pub. No.: US 2023/0128647 A1
(43) Pub. Date: Apr. 27, 2023

(54) MANUFACTURING METHOD FOR VEHICLE KNUCKLE USING PREFORM

(71) Applicant: ILJIN CO., LTD., Gyeongju-si Gyeongsangbuk-do (KR)

(72) Inventors: Se Woong JEONG, Ulsan (KR); Ig Jin KWON, Daegu (KR); Hyun Tae BANG, Incheon (KR); Ki Ho KIM, Cheongju-si, Chungcheongbuk-do (KR); Ju Hyoung CHO, Pohang-si, Gyeongsangbuk-do (KR)

(73) Assignee: ILJIN CO., LTD., Gyeongju-si Gyeongsangbuk-do (KR)

(21) Appl. No.: 17/789,361

(22) PCT Filed: Dec. 30, 2019
(86) PCT No.: PCT/KR2019/018751

§ 371 Date: Jan. 9, 2023

(30) Foreign Application Priority Data
Dec. 27, 2019 (KR) 10-2019-0177177

(51) Int. Cl. B29B 11/14; B29B 11/12; B62D 7/18; B29C 43/18

(52) U.S. Cl. CPC B29B 11/14; B29B 11/12; B29C 43/18; B62D 7/18; B29L 2031/30

(57) ABSTRACT

There is provided method of manufacturing a knuckle for a vehicle. The method includes a preform forming operation of forming a preform serving as a preliminary molding object for forming the knuckle for a vehicle; and a main-molding-object forming operation of hot-pressing the preform to form a main molding object for forming the knuckle for a vehicle. The preform formed in the preform forming operation may be formed in a shape corresponding to a shape of the main molding object, and may be formed in a shape offset inward by a predetermined dimension from an outer shape of the main molding object.

### CROSS REFERENCE TO RELATED APPLICATIONS

This application is a national phase of International Application No. PCT/KR2019/018751 filed on Dec. 30, 2019, which claims priority to Korean Patent Application No. 10-2019-0177177 filed on Dec. 27, 2019, the entire contents of which are herein incorporated by reference.

### TECHNICAL FIELD

The present disclosure relates to a method of manufacturing a knuckle for a vehicle used in a steering device of a vehicle, and more particularly to a method of manufacturing a knuckle for a vehicle constituted so that productivity and rigidity are improved by manufacturing the knuckle for a vehicle using a pre-molded preform.

The present disclosure has been derived from a study conducted as Advanced Technology Center (ATC) project of Korea Evaluation Institute of Industrial Technology of Ministry of Trade, Industry and Energy [Project Number: 10076991, Research Subject Name: Development of carbon composite knuckle for vehicle, which is 40% lighter than steel using monofilament/hot-press forming process]

### BACKGROUND

A knuckle for a vehicle is a part that constitutes a steering device of the vehicle, and is coupled to a wheel bearing that rotatably mounts and supports a wheel to a vehicle axis so as to perform a function of controlling a driving direction of the vehicle.

In general, such a vehicular knuckle has been formed by molding a metallic material using a casting or the like in order to ensure rigidity required for components for vehicle. However, in recent years, various studies have been conducted to improve a material and structure of a knuckle for a vehicle with increased demands for a decrease in weight of components for a vehicle and increased fuel efficiency.

As an example, Patent Document 1 discloses a technique for manufacturing a knuckle for a vehicle using material such as carbon chip. Specifically, as illustrated in FIG. 1, the knuckle for a vehicle disclosed in Patent Document 1 is formed to include a plurality of flanges (a first flange 20, a second flange 30, a third flange 40, and a fourth flange 50) used to connect the knuckle to other parts of the vehicle on one side of a knuckle body 10. A perforated wheel bearing mounting hole 12 is formed in a central portion of the knuckle body 10 so that a wheel bearing (not illustrated) is mounted on the knuckle body 10 through the wheel bearing mounting hole 12. On the other hand, a hub bushing 60 is mounted on one side of the wheel bearing mounting hole 12 so that a wheel bearing (not illustrated) is coupled to the knuckle body 10 through the hub bushing 60, and fastening holes 14 are formed around the wheel bearing mounting hole 12 so that the wheel bearing is fixed to the knuckle body 10 through fastening members.

In addition, Patent Document 1 discloses a method of manufacturing the knuckle for a vehicle described above by using a lightweight carbon-based material such as a carbon chip. For example, as illustrated in FIG. 2, the knuckle for a vehicle disclosed in Patent Document 1 is formed by filling a recess 75 formed in a mold 70 with the carbon-based material such as carbon chips, and then hot-pressing the material in a high-temperature and high-pressure environment.

However, the formation of the knuckle for a vehicle in this manner requires a process of measuring an amount of the carbon chips necessary for manufacturing the knuckle for a vehicle, and then filling small-sized carbon chips into the recess 75 formed in the mold 70 by the measured amount. Such a carbon chip filling process is manually performed, which takes a long period of process time. This may result in a degradation of productivity of the knuckle for a vehicle.

In addition, in the method of manufacturing the knuckle for a vehicle described above, in the course of filling small-sized carbon chips into the recess of the mold in a manual manner, different amounts of carbon chips may be introduced to different positions so that a manufactured knuckle may have different material densities for each position. This may cause a matter in that the rigidity of the knuckle for a vehicle is different for each position.

### Document in Related Art

### Patent Document

Patent Document 1: Korean Patent Application Registration No. 10-1857170 (registered on May 4, 2018)

### SUMMARY

The present disclosure was made in view of the above-mentioned matters in the related art, and the present disclosure is for the purpose of providing a method of manufacturing a knuckle for a vehicle which is capable of manufacturing a knuckle for a vehicle in a faster and easier manner compared with the related art and capable of ensuring uniform rigidity as a whole, by manufacturing the knuckle for a vehicle with a preform formed in advance in a shape corresponding to the knuckle for a vehicle to be manufactured (specifically, in a shape slightly offset by a predetermined amount from the knuckle for a vehicle to be manufactured).

Representative configurations of the present disclosure for achieving the above aspects are described below.

According to an example embodiment of the present disclosure, there is provided a method of manufacturing a knuckle for a vehicle. The method according to an example embodiment of the present disclosure may comprise: a preform forming operation of forming a preform serving as a preliminary molding object for forming the knuckle for a vehicle; and a main-molding-object forming operation of hot-pressing the preform to form a main molding object for forming the knuckle for a vehicle, wherein the preform formed in the preform forming operation may be formed in a shape corresponding to a shape of the main molding object, and may be formed in a shape offset inward by a predetermined dimension from an outer shape of the main molding object.

According to an example embodiment of the present disclosure, the preform formed in the preform forming operation may be formed in a shape offset inward by 1 mm to 3 mm from the outer shape of the main molding object when viewed in a direction along an axial direction of the knuckle for a vehicle.

According to an example embodiment of the present disclosure, the preform formed in the preform forming operation may be formed thicker than the main molding object by a predetermined dimension.

According to an example embodiment of the present disclosure, the preform formed in the preform forming operation may be formed thicker than the main molding object by 1 mm to 3 mm along an axial direction of the knuckle for a vehicle.

According to an example embodiment of the present disclosure, the preform forming operation may comprise: a preform-mold preparation operation of preparing a preform mold in which a recess having a shape corresponding to the shape of the preform is formed; a material filling operation of filling material for forming the preform into the recess of the preform mold; a preform molding operation of molding the material filled into the recess of the preform mold to form the preform; and a preform separating operation of separating the molded preform from the preform mold.

According to an example embodiment of the present disclosure, the method may further comprise a bushing insertion operation of inserting some or all of bushings to be coupled to the knuckle for a vehicle into the recess formed in the preform mold between the preform-mold preparation operation and the material filling operation.

According to an example embodiment of the present disclosure, in the material filling operation, an amount of material required to form the main molding object may be filled into the recess of the preform mold.

According to an example embodiment of the present disclosure, the material filled into the recess of the preform mold to form the preform in the material filling operation may be carbon chip material.

According to an example embodiment of the present disclosure, the main-molding-object forming operation may comprise: a main-molding-object-mold preparation operation of preparing a main-molding-object mold in which a recess having a shape corresponding to the shape of the main molding object is formed; a preform insertion operation of inserting the preform into the recess of the main-molding-object mold; a hot-pressing operation of hot-pressing the preform inserted into the recess of the main-molding-object mold to form the main molding object; and a main-molding-object separating operation of separating the hot-pressed main molding object from the main-molding-object mold.

According to an example embodiment of the present disclosure, the method may further comprise: after the main-molding-object forming operation, a post-processing and/or bushing coupling operation of performing subsequent processing necessary for the main molding object and/or coupling a bushing(s) necessary for the knuckle for a vehicle.

Further, the method of manufacturing a knuckle for a vehicle according to the present disclosure may further comprise other additional configurations without departing from the technical sprit of the present disclosure.

A method of manufacturing a knuckle for a vehicle according to an example embodiment of the present disclosure is configured to form a preform having a shape corresponding to a knuckle for a vehicle to be manufactured in advance, and then perform a hot-pressing process on the preform to form the knuckle for a vehicle. Thus, it is possible to manufacture the knuckle for a vehicle in a faster and easier manner. Furthermore, a main molding object of the knuckle for a vehicle is formed integrally as a whole by being subjected to the hot-pressing, which makes it possible to ensure uniform rigidity of the knuckle for a vehicle as a whole.

Further, the method of manufacturing a knuckle for a vehicle according to an example embodiment of the present disclosure is configured to form a preform serving as a preliminary molding object by using the same amount of material (for example, carbon-based material such as carbon chip) as material necessary for forming the knuckle for a vehicle (for example, a main molding object of the knuckle) to be manufactured. Thus, even if the knuckle for a vehicle is formed using the preform, it becomes unnecessary to fill an additional material in an operation of forming the main molding object, which makes it possible to shorten a process time required for a material filling operation and further improve the productivity of the knuckle for a vehicle.

In addition, the method of manufacturing a knuckle for a vehicle according to an example embodiment of the present disclosure is configured to form a preform serving as a preliminary molding object in a shape offset inward from an outer shape of a main molding object by a predetermined dimension. Thus, when the preform is inserted into a main-molding-object mold to forming the main molding object of the knuckle, the preform may be easily inserted into and mounted on the main-molding-object mold without interference with the main-molding-object mold. This makes it possible to perform the process of manufacturing the knuckle for a vehicle in a faster and easier manner.

### BRIEF DESCRIPTION OF THE DRAWINGS

FIG. 1 exemplarily illustrates an example of a knuckle for a vehicle in the related art.

FIG. 2 exemplarily illustrates a mold that may be used in manufacturing the knuckle for a vehicle illustrated in FIG. 1.

FIG. 3 exemplarily illustrates an overall structure of the knuckle for a vehicle according to an example embodiment of the present disclosure.

FIG. 4 exemplarily illustrates a method of manufacturing the knuckle for a vehicle according to an example embodiment of the present disclosure.

FIG. 5 exemplarily illustrates a process of forming a preform in the method of manufacturing the knuckle for a vehicle according to an example embodiment of the present disclosure.

FIG. 6 exemplarily illustrates a preform (preliminary molding object) that may be used in manufacturing the knuckle for a vehicle according to an example embodiment of the present disclosure.

FIG. 7 exemplarily illustrates a state in which the preform is formed in the method of manufacturing the knuckle for a vehicle according to an example embodiment of the present disclosure.

FIG. 8 exemplarily illustrates a process of forming a main molding object with the preform in the method of manufacturing the knuckle for a vehicle according to an example embodiment of the present disclosure.

FIG. 9 exemplarily illustrates a shape of the main molding object formed with the preform according to an example embodiment of the present disclosure.

FIG. 10 exemplarily illustrates a state in which the main molding object is formed with the preform in the method of manufacturing the knuckle for a vehicle according to an example embodiment of the present disclosure.

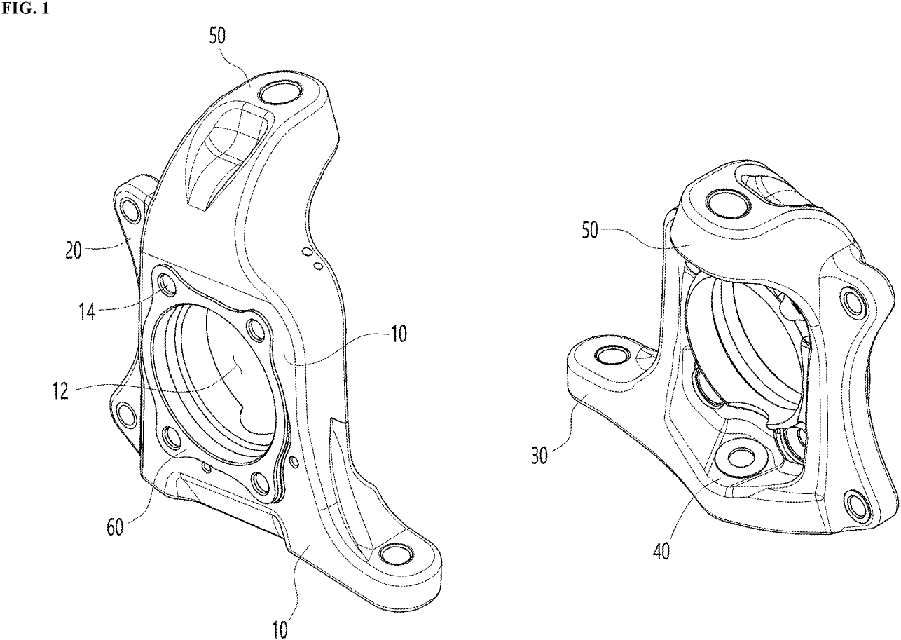

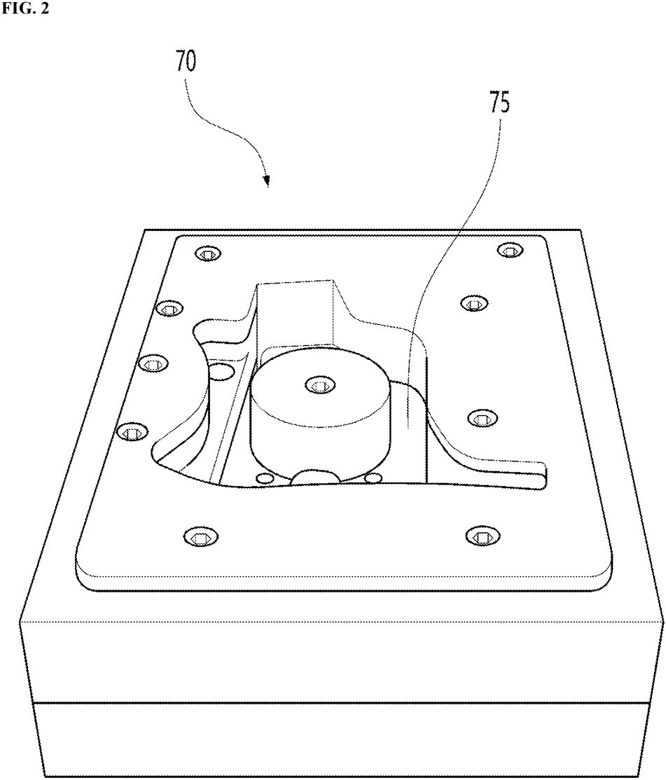

### EXPLANATION OF REFERENCE NUMERALS

100: knuckle for a vehicle, 110: knuckle body, 112: wheel bearing mounting hole, 114: fastening hole, 120: first flange, 122: fastening hole (of first flange), 124: caliper bushing, 130: second flange, 132: fastening hole (of second flange), 134: tie rod bushing, 140: third flange, 142: fastening hole (of third flange), 144: suspension arm bushing, 150: fourth flange, 152: fastening hole (of fourth flange), 154: strut bushing, 200: preform, 210: preform body, 212: through-hole (formed in preform body), 220: first preform flange, 230: second preform flange, 240: third preform flange, 250: fourth preform flange, 300: main molding object, 310: main-molding-object body, 312: through-hole (formed in main-molding-object body), 320: first main-molding-object flange, 330: second main-molding-object flange, 340: third main-molding-object flange, 350: fourth main-molding-object flange, 400: preform mold, 410: lower preform mold, 420: recess (formed in lower preform mold), 430: protrusion (formed in lower preform mold), 440: upper preform mold, 500: main-molding-object mold, 510: lower main-molding-object mold, 520: recess (formed in lower main-molding-object mold), 530: protrusion (formed in lower main-molding-object mold), 540: upper main-molding-object mold.

### DETAILED DESCRIPTION

Hereinafter, example embodiments of the present disclosure will be described in detail with reference to the accompanying drawings at such an extent that they may be readily practiced by those ordinary skilled in the art.

In order to clearly describe the present disclosure, descriptions of parts irrelevant to the present disclosure will be omitted, and the same/similar reference numerals will be given to the same/similar constituent elements throughout the specification. Further, a size, thickness and position of each constituent element illustrated in the figures are arbitrarily illustrated for the sake of convenience in description, and hence the present disclosure is not necessarily limited to those illustrated. That is, it is to be understood that specific shapes, structures, and characteristics described herein may be modified from an example embodiment to another example embodiment without departing from the spirit and scope of the present disclosure. Positions or arrangements of individual constituent elements may also be modified without departing from the spirit and scope of the present disclosure. Therefore, the detailed description described below is not to be taken in a limiting sense, and the scope of the present disclosure is to be taken as covering the scope claimed by the appended claims and their equivalents.

Knuckle for a Vehicle according to an Example Embodiment of the Present Disclosure

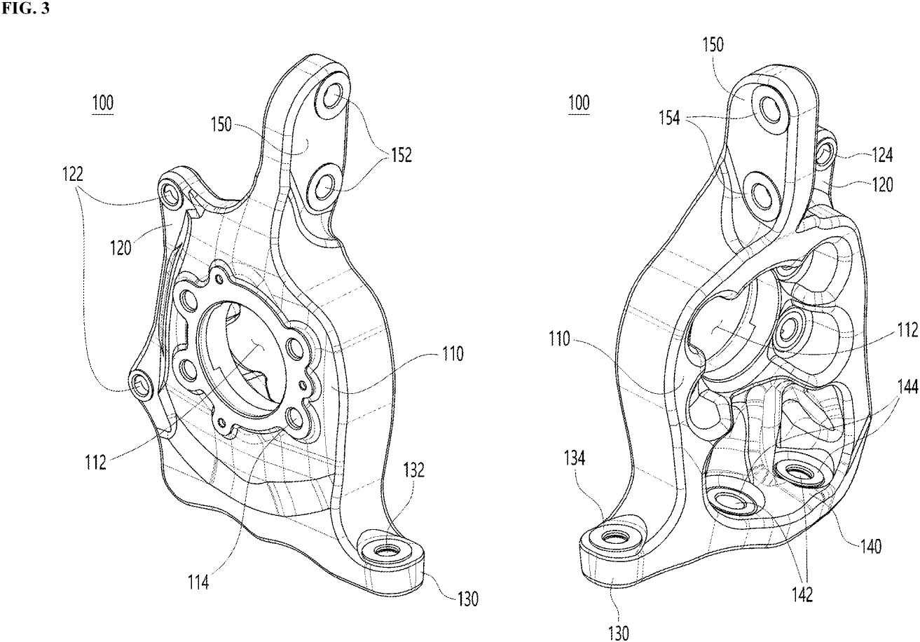

Referring to FIG. 3, there is exemplarily illustrated an overall structure of a knuckle for a vehicle 100 that may be formed according to an example embodiment of the present disclosure. As illustrated in FIG. 3, a knuckle for a vehicle according to an example embodiment of the present disclosure may be formed in a structure that is generally similar to a knuckle for a vehicle in the related art. For example, the knuckle for a vehicle 100 according to an example embodiment of the present disclosure may be configured to comprise a knuckle body 110, and one or more flanges (for example, a first flange 120, a second flange 130, a third flange 140, a fourth flange 150, and the like) that extend from the knuckle body 110 to connect the knuckle to other components of the vehicle.

According to an example embodiment of the present disclosure, the knuckle body 110 is a portion that defines a body of the knuckle. A wheel bearing mounting hole 112 is formed to penetrate the central portion of the knuckle body 110. A wheel bearing (not illustrated) may be mounted on the knuckle body 110 through the wheel bearing mounting hole 112. On the other hand, a plurality of fastening holes 114 may be formed around the wheel bearing mounting hole 112 so that the wheel bearing is fixed to the knuckle body 110 through the fastening bolts or the like.

According to an example embodiment of the present disclosure, the first flange 120 is a portion to which a brake caliper is connected, and may be formed to extend along one side of the knuckle body 110. According to an example embodiment of the present disclosure, the first flange 120 may be provided with fastener holes 122. Caliper bushings 124 are may be inserted into the respective fastener holes 122 so that the knuckle is connected to the brake caliper.

According to an example embodiment of the present disclosure, the second flange 130 is a portion to which a tie rod is connected, and may be formed in a direction that is approximately perpendicular to a plane of the knuckle body 110 on one side of the knuckle body 110. According to an example embodiment of the present disclosure, the second flange 130 is provided with a fastening hole 132 and a tie rod bushing 134 is inserted into the fastening hole 132 so that the knuckle is connected to the tie rod.

According to an example embodiment of the present disclosure, the third flange 140 is a portion to which a suspension arm (for example, a lower arm) constituting a suspension device is connected, and may be formed in a direction that is approximately perpendicular to the plane of the knuckle body 110 on one side of the knuckle body 110. According to an example embodiment of the present disclosure, the third flange 140 is provided with fastener holes 142, and a suspension arm bushing 144 is inserted into the respective fastener holes 142 so that the knuckle is connected to the suspension arm.

According to an example embodiment of the present disclosure, the fourth flange 150 is a portion to which a strut assembly constituting the suspension device is connected, and may be formed in a direction that is approximately perpendicular to the plane of the knuckle body 110 on one side of the knuckle body 110. According to an example embodiment of the present disclosure, the fourth flange 150 is provided with fastener holes 152, and strut bushings 154 are inserted into the respective fastener holes 152 so that the knuckle is connected to the strut assembly.

The example embodiments illustrated in the drawings are exemplarily illustrated to describe the knuckle for a vehicle 100 according to an example embodiment of the present disclosure, but the knuckle for a vehicle 100 according to an example embodiment of the present disclosure is not limited to the structure illustrated in the drawings and may be changed into other various structures.

Further, the knuckle for a vehicle according to an example embodiment of the present disclosure may be configured to be manufactured using carbon-based material such as carbon chip, as will be described later. Specifically, the knuckle for a vehicle according to an example embodiment of the present disclosure may be manufactured by forming, with the carbon-based material such as the carbon chip, a preform serving as a preliminary molding object in a shape corresponding to the knuckle for a vehicle to be manufactured, and using the formed preform.

With this configuration, the knuckle for a vehicle according to an example embodiment of the present disclosure may be manufactured with a lighter weight than the knuckle for a vehicle formed of a metallic material in the related art. Further, by forming the knuckle for vehicle using the preform, it is possible to manufacture the knuckle for a vehicle with improved manufacturing property and rigidity even in the case of manufacturing the knuckle for a vehicle using the carbon-based material such as the carbon chip.

According to an example embodiment of the present disclosure, a method of manufacturing the knuckle for a vehicle with the preform formed of the carbon-based material such as the carbon chip will be described in more detail below.

On the other hand, the knuckle for a vehicle according to the example embodiment illustrated in FIG. 3 is formed in a MacPherson strut type of knuckle structure, but the knuckle for a vehicle according to the present disclosure is not limited thereto and may be formed in other knuckle structures, such as a double wishbone type, a multi-link type, or the like.

Method of Manufacturing a Knuckle for a Vehicle according to an Example Embodiment of the Present Disclosure

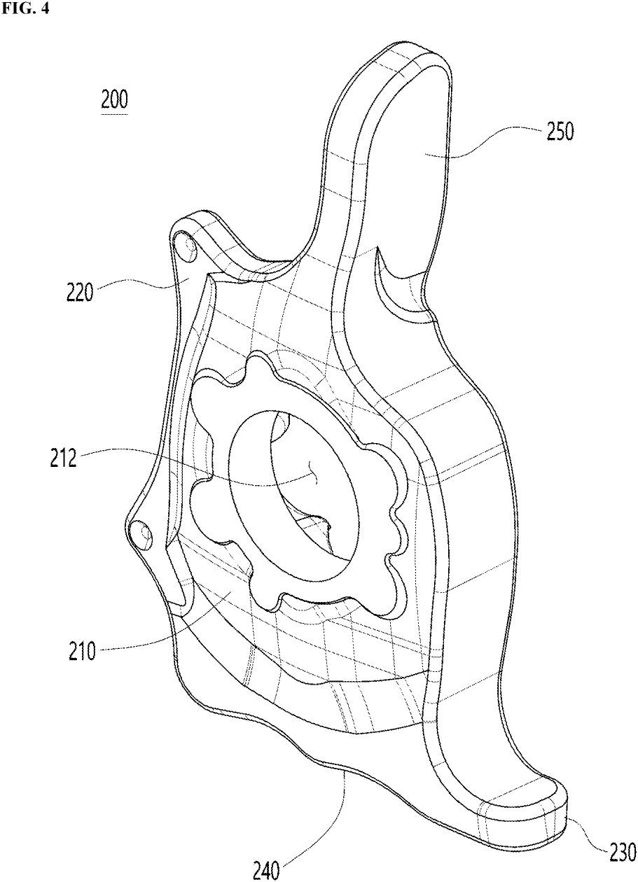

Next, a method of manufacturing a knuckle for a vehicle according to an example embodiment of the present disclosure will be described in detail with reference to FIGS. 4 to 10.

Although a plurality of operations of the method of manufacturing the knuckle for a vehicle according to an example embodiment of the present disclosure described below have been described in a sequential order, these operations may not be necessarily performed in the sequence described below. For example, the order of some operations may be changed, some of the operations may be omitted, additional operations may be added, or some of the operations may be performed in a simultaneous manner.

As illustrated in FIG. 4, the method of manufacturing the knuckle for a vehicle according to an example embodiment of the present disclosure may comprise: a preform forming operation S100 of forming a preform 200 serving as a preliminary molding object for forming the knuckle for a vehicle; and a main-molding-object forming operation S200 of hot-pressing the preform formed in the preform forming operation to form a main molding object of the knuckle for a vehicle to be manufactured. The method further may comprise, after the main-molding-object forming operation, a post-processing and/or bushing coupling operation S300 of performs a post-processing necessary for the main molding object and/or coupling a bushing(s) to be mounted to the knuckle for a vehicle so as to form a final product of the knuckle for a vehicle according to an example embodiment of the present disclosure.

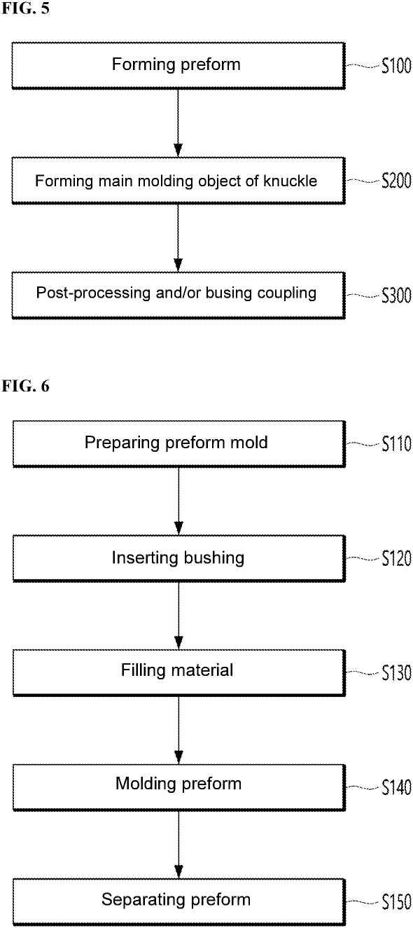

Specifically, in the method of manufacturing the knuckle for a vehicle according to an example embodiment of the present disclosure, the preform forming operation S100 is an operation of forming the preliminary molding object (preform) for forming the knuckle for a vehicle according to an example embodiment of the present disclosure. As illustrated in FIG. 5, the preform forming operation S100 may comprise: a preform-mold preparation operation S110 of preparing a preform mold in which a recess having a shape corresponding to a shape of the preform is formed; a material filling operation S130 of filling material such as carbon chip C into the recess of the preform mold; a preform molding operation S140 of molding the material filled into the recess of the preform mold to form the preform; and a preform separating operation S150 of separating the molded preform from the preform mold. Further, the method may further comprise, before the material filling operation S130, a bushing insertion operation S120 of inserting and positioning a bushing(s) (for example, hub bushing) into the recess of the preform mold in order to ensure more productive manufacture.

According to an example embodiment of the present disclosure, as illustrated in FIG. 6, the preform 200 may be formed in a shape that is generally similar to a knuckle (for example, main molding object) for a vehicle to be manufactured, and may be formed in a shape offset inward from an outer shape of the main molding object by a predetermined dimension.

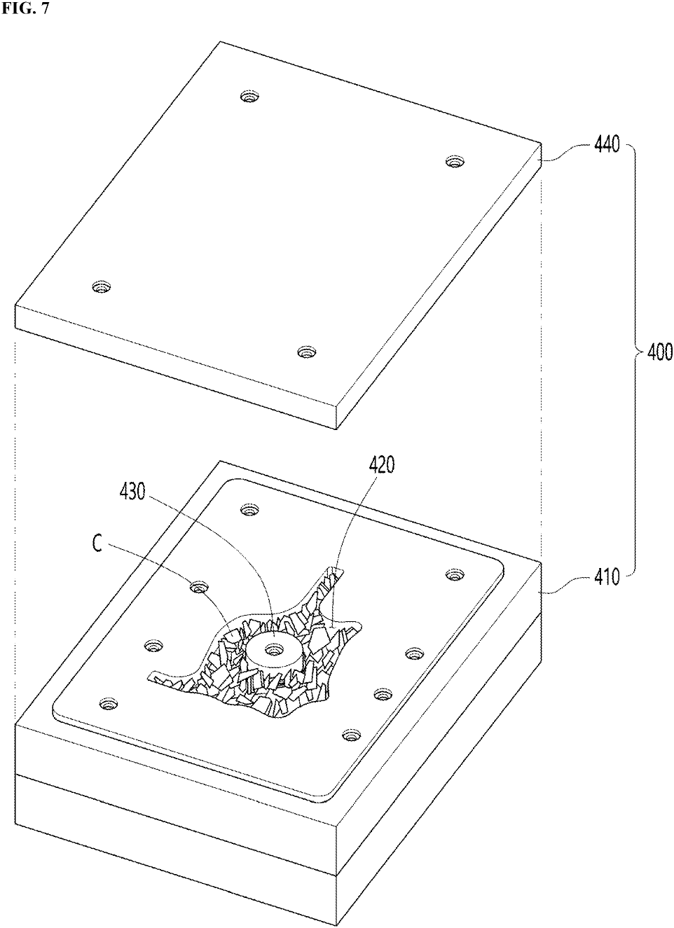

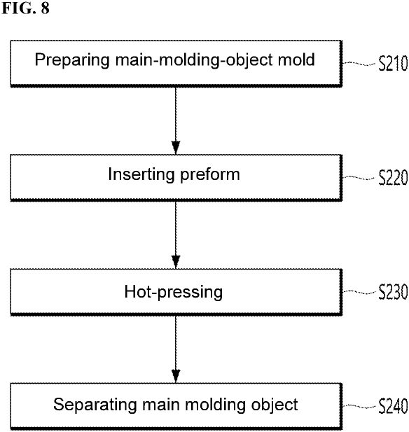

For example, as illustrated in FIG. 6, the preform 200 may comprise a preform body 210, and one or more preform flanges (for example, a first preform flange 220, a second preform flange 230, a third preform flange 240, a fourth preform flange 250, and the like) that extend from the preform body 210, and may be formed in a substantially similar shape to a shape of the main molding object of the knuckle for a vehicle to be manufactured. For example, the preform 200 may be formed such that, when viewed in a direction along an axial direction of the knuckle (direction along a central axis of the wheel bearing mounting hole) (that is, when viewed in a direction of pressing the mold (direction perpendicular to the mold) as illustrated in FIG. 7), an outer periphery thereof is offset inward from an outer periphery of the main molding object by a predetermined dimension and has a smaller dimension than the outer periphery of the main molding object. A through-hole 212 formed inside the preform 200 (through-hole corresponding to the wheel bearing mounting hole) may be formed to have a relatively large size while being offset inward from the main molding object by a predetermined dimension.

As described above, in the method of manufacturing the knuckle for a vehicle according to an example embodiment of the present disclosure, the preform is configured to be formed in the shape offset inward by the predetermined dimension from the main molding object of the knuckle for a vehicle to be manufactured. Thus, when inserting the preform into the main-molding-object mold to form the main molding object as described later, the preform may be smoothly inserted into the main-molding-object mold without interference with the main-molding-object mold, which makes it possible to perform the process of manufacturing the knuckle for a vehicle in a faster and easier manner.

According to an example embodiment of the present disclosure, in order to stably manufacture the knuckle for a vehicle while minimizing the interference between the preform and the main-molding-object mold, the preform 200 may be formed in a shape offset inward by 1 mm to 3 mm from the outer shape of the main molding object 300.

According to an example embodiment of the present disclosure, in the preform-mold preparation operation S110, a preform mold 400 for forming the preform is prepared. As illustrated in FIG. 7, the preform mold 400 may be configured to comprise a lower preform mold 410 in which a recess 420 having a shape corresponding to the shape of the preform is provided, and an upper preform mold 440 that presses the lower preform mold 410.

According to an example embodiment of the present disclosure, the recess 420 provided in the lower preform mold 410 may be formed such that an outer periphery thereof has a shape corresponding to an outer periphery of the preform 200, and a central portion thereof is provided with a protrusion 430 having a shape corresponding to the through-hole 212 provided in the central portion of the preform 200. To do this, the through-hole 212 corresponding to the wheel bearing mounting hole of the knuckle for a vehicle is formed in the central portion of the preform 200.

As described above, in the method of manufacturing the knuckle for a vehicle according to an example embodiment of the present disclosure, since the preform 200 is formed in a structure offset inward by a predetermined dimension from the main molding object of the knuckle for a vehicle to be manufactured, the recess 420 provided in the lower preform mold 410 may be formed such that the outer periphery thereof is formed in a smaller size than the main molding object of the knuckle for a vehicle to be manufactured and the protrusion 430 for forming to the through-hole is formed in a larger size than the wheel bearing mounting hole of the knuckle for a vehicle to be manufactured (that is, the through-hole formed in the central portion of the main molding object).

According to an example embodiment of the present disclosure, in the bushing insertion operation S120, some or all of the bushings that are to be coupled to the knuckle body or the flanges of the knuckle for a vehicle may be inserted into and positioned in the preform mold (for example, a hub bushing or the like that are to be mounted approximately perpendicular to the knuckle body may be disposed inside the preform mold). When forming the preform 200 in a state in which some or all of the bushings provided in the knuckle for a vehicle are mounted in the recess 420 formed in the preform mold 400 in advance as described above, the preform 200 may be formed while being coupled integrally with the bushing(s). This makes it possible to further enhance the productivity of the knuckle for a vehicle according to an example embodiment of the present disclosure.

However, the bushing insertion operation S120 may not be necessarily performed and may be selectively performed as needed.

According to an example embodiment of the present disclosure, in the material filling operation S130, material such as carbon chip C for molding the preform may be filled into the recess 420 provided in the lower preform mold 410 (see FIG. 7). In an example embodiment of the present disclosure, the carbon chip C may be a carbon-based material cut in a chip shape of a predetermined size. The carbon chip C may be formed of a chip-shaped material having a length of about 10 mm to 150 mm and a width of about 3 mm to 20 mm.

According to an example embodiment of the present disclosure, the material filling operation S130, a same amount of material as material necessary for forming the main molding object of the knuckle for a vehicle to be manufactured may be filled into the recess 420 of the preform mold.

As described above, the preform is formed using the same amount of material (for example, carbon-based material such as carbon chip) as material necessary for forming the main molding object of the knuckle for a vehicle to be manufactured. This eliminates a need to supplement an additional material into the main-molding-object mold in the subsequent main-molding-object forming operation. This makes it possible to simplify the manufacturing process of the knuckle for a vehicle and further improve the productivity.

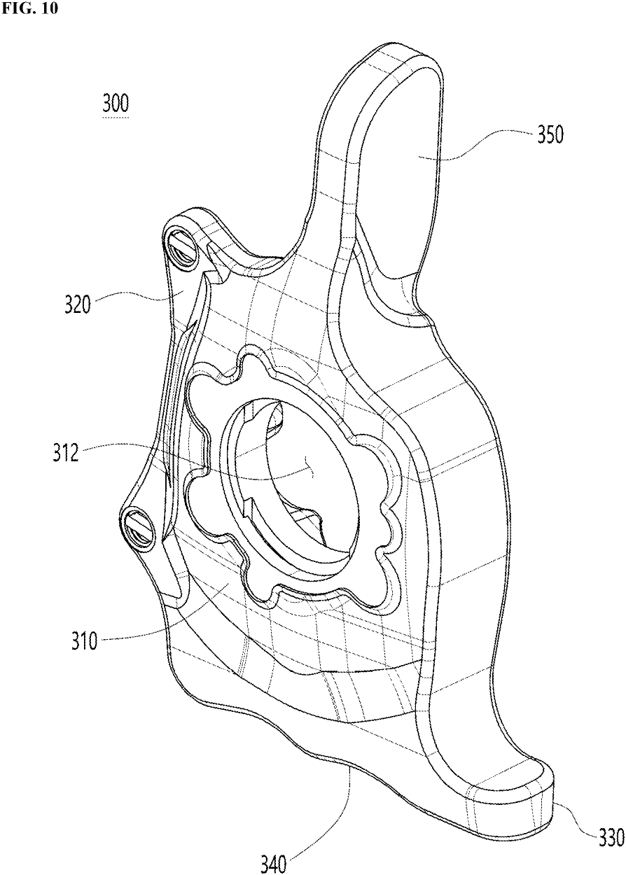

Further, even if the preform 200 used in the method of manufacturing the knuckle for a vehicle according to an example embodiment of the present disclosure is formed in a shape offset inward from the main molding object 300 (see FIG. 9) of the knuckle for a vehicle to be manufactured, the preform 200 is formed using the same amount of material as the amount required to form the main molding object. The preform 200 may be formed thicker than a thickness (axial thickness of the knuckle) of the main molding object 300 in the axial direction by a predetermined dimension. For example, according to an example embodiment of the present disclosure, the preform may be formed thicker than the main molding object by 1 mm to 3 mm along the axial direction of the knuckle.

According to an example embodiment of the present disclosure, in the preform molding operation S140, the preform 200 may be formed by molding the material filled into the preform mold 400 at a predetermined temperature and pressure. After the preform is molded, the preform separating operation S150 may be performed to separate the molded preform from the preform mold.

Further, after the preform 200 is molded by the above-described operation, the main-molding-object forming operation S200 of forming the main molding object of the knuckle for a vehicle using the molded preform, may be performed.

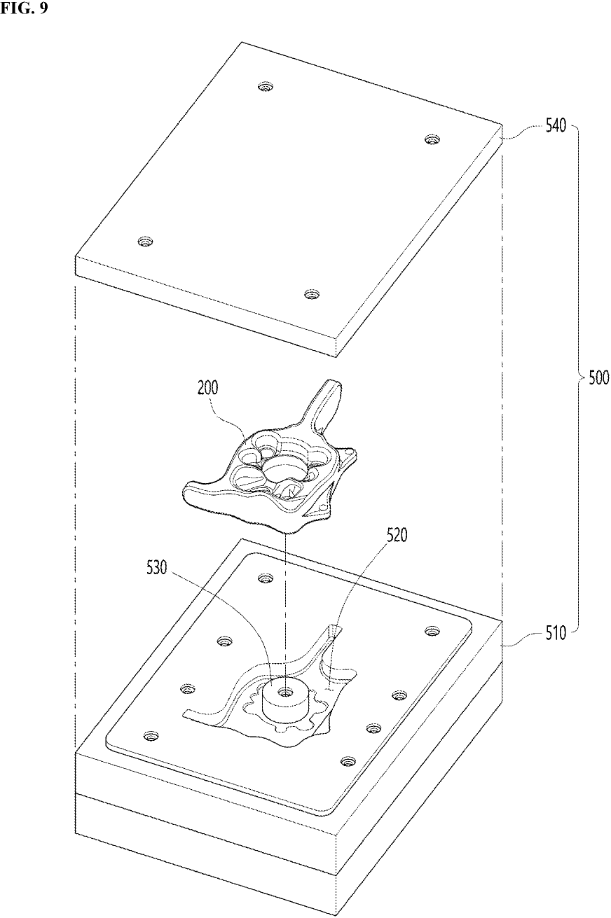

According to an example embodiment of the present disclosure, as illustrated in FIG. 8, the main-molding-object forming operation S200 may comprise: a main-molding-object mold preparation operation S210 of preparing a main-molding-object mold in which a recess having a shape corresponding to the main molding object is formed; a preform insertion operation S220 of inserting and mounting the preform into and on the recess of the main-molding-object mold; a hot-pressing operation S230 of hot-pressing the preform inserted into the recess of the main-molding-object mold to form the main molding object for the knuckle for a vehicle according to an example embodiment of the present disclosure; and a main-molding-object separating operation S240 of separating the hot-pressed main molding object from the main-molding-object mold.

According to an example embodiment of the present disclosure, in the main-molding-object mold preparation operation S210, a main-molding-object mold 500 in which a recess having a shape corresponding to the main molding object of the knuckle for a vehicle to be manufactured is formed, may be prepared. For example, the main-molding-object mold 500 may comprise a lower main-molding-object mold 510 and an upper main-molding-object mold 540 similarly to the preform mold 400 described above. The lower main-molding-object mold 510 may be provided with a recess 520 having a shape corresponding to the main molding object to be manufactured. According to an example embodiment of the present disclosure, as illustrated in FIG. 10, the recess 520 provided in the lower main-molding-object mold 510 has an outer periphery of a shape corresponding to the main molding object 300. A protrusion for forming a through-hole 312 to be provided in the main molding object 300 may be formed to protrude in the recess 520.

According to an example embodiment of the present disclosure, the main molding object 300 may be a molded product having substantially the same shape as the knuckle for a vehicle 100 to be manufactured. As illustrated in FIG. 9, the main molding object 300 may comprise a main-molding-object body 310, and one or more main-molding-object flanges (a first main-molding-object flange 320, a second main-molding-object flange 330, a third main-molding-object flange 340, a fourth main-molding-object flange 350, and the like) formed to extend from the main-molding-object body 310, and may be formed to have substantially the same shape as the knuckle for a vehicle 100 to be manufactured.

According to an example embodiment of the present disclosure, in the preform insertion operation S220, the preform 200 formed in the preform forming operation S100 is inserted into and mounted on the recess 520 formed in the main-molding-object mold. As described above, in the method of manufacturing the knuckle for a vehicle according to an example embodiment of the present disclosure, the preform 200 is formed in a structure offset inward by the predetermined dimension from the main molding object 300 of the knuckle for a vehicle to be manufactured. Thus, the preform 200 may be easily inserted into the recess 520 of the main-molding-object mold formed, which has the shape corresponding to the main molding object 300. For example, an outer periphery of the preform 200 may be formed smaller than an outer periphery of the recess 520 provided in the main-molding-object mold, and the through-hole 212 formed in the central portion of the preform 200 may be formed larger than the protrusion 530 provided in the recess 520 of the main-molding-object mold. This makes it possible to easily insert the preform 200 into the recess 520 of the main-molding-object mold without any considerable interference.

According to an example embodiment of the present disclosure, in the hot-pressing operation S230, the preform 200 inserted into the main-molding-object mold may be hot-pressed at a predetermined temperature and pressure (for example, in a high-temperature and high-pressure condition). After the hot-pressing, the main-molding-obj ect separating operation S240 may be performed to separate the hot-pressed main molding object 300 from the main-molding-object mold 500.

Further, after the main molding object 300 is formed, a post-processing and/or bushing coupling operation S300 of performing a subsequent processing such as trimming, machining, or the like on the main molding object 300 in consideration of the final shape of the knuckle for a vehicle 100 to be manufactured, or coupling a bushing(s) to a necessary portion, may be further performed, as needed. As a result, the manufacture of the knuckle for a vehicle 100 according to an example embodiment of the present disclosure may be completed.

For example, in the post-processing and/or bushing coupling operation S300, a trimming process of removing molded residue that adheres to an edge portion of the main molding object formed through the hot-pressing, a hole processing of forming a bushing fastening hole(s) in the flange or the like of the main molding object 300, or the like, may be performed. Further, a process of coupling a bushing(s) (for example, the tie rod bushing 134, the suspension arm bushing 144, the strut bushing 154, or the like) to a necessary portion may be performed.

As described above, when the knuckle for a vehicle 100 is manufactured by the above-described method of manufacturing the knuckle for a vehicle according to an example embodiment of the present disclosure, in the case in which the knuckle for a vehicle 100 is formed with carbon-based material such as carbon chip to reduce the weight of the knuckle for a vehicle 100, the material filling operation of filling the carbon-based material such as the carbon chip may be merely performed in the operation of forming the preform as a preliminary molding object in a rough shape. Further, the material filling operation, which takes a long period of processing time, may be omitted in a main molding operation of forming a final molded product of the knuckle for a vehicle. This makes it possible to greatly improve the productivity of the knuckle for a vehicle.

In addition, the preform used in the method of manufacturing the knuckle for a vehicle according to an example embodiment of the present disclosure is formed in a shape approximately corresponding to the final shape of the knuckle for a vehicle to be manufactured, and the preform is hot-pressed to form the main molding object of the knuckle for a vehicle to be manufactured. Thus, through the hot-pressing of the main molding object, the knuckle for a vehicle may have a uniform rigidity as a whole.

In addition, in the method of manufacturing the knuckle for a vehicle according to an example embodiment of the present disclosure, the preform serving as a preliminary molding object is formed in a shape corresponding to the main molding object of the knuckle for a vehicle to be manufactured and is formed in a shape offset inward by a predetermined dimension from the outer shape of the main molding object. Thus, even if the preform is formed in the shape corresponding to the main molding object of the knuckle for a vehicle to be manufactured, when the preform is inserted into the main-molding-object mold to form the main molding object, interference between the preform and the main-molding-object mold may be minimized. This makes it possible to perform the process of manufacturing the knuckle for a vehicle more quickly and easily.

Although the present disclosure has been described above in terms of specific items such as detailed constituent elements as well as the limited example embodiments, they are merely provided to help more general understanding of the present disclosure, and the present disclosure is not limited to the above example embodiments. Various modifications and changes could have been realized by those skilled in the art to which the present disclosure pertains from the above description.

Therefore, the spirit of the present disclosure need not to be limited to the above-described example embodiments, and in addition to the appended claims to be described below, and all ranges equivalent to or changed from these claims need to be said to belong to the scope and spirit of the present disclosure.

1. A method of manufacturing a knuckle for a vehicle, the method comprising:
a preform forming operation of forming a preform serving as a preliminary molding object for forming the knuckle for a vehicle; and
a main-molding-object forming operation of hot-pressing the preform to form a main molding object for forming the knuckle for a vehicle,
wherein the preform formed in the preform forming operation is formed in a shape corresponding to a shape of the main molding object, and is formed in a shape offset inward by a predetermined dimension from an outer shape of the main molding object.

2. The method of claim 1, wherein the preform formed in the preform forming operation is formed in a shape offset inward by 1 mm to 3 mm from the outer shape of the main molding object when viewed in a direction along an axial direction of the knuckle for a vehicle.

3. The method of claim 1, wherein the preform formed in the preform forming operation is formed thicker than the main molding object by a predetermined dimension.

4. The method of claim 3, wherein the preform formed in the preform forming operation is formed thicker than the main molding object by 1 mm to 3 mm along an axial direction of the knuckle for a vehicle.

5. The method of claim 3, wherein the preform forming operation comprises:
a preform-mold preparation operation of preparing a preform mold in which a recess having a shape corresponding to the shape of the preform is formed;
a material filling operation of filling material for forming the preform into the recess of the preform mold;
a preform molding operation of molding the material filled into the recess of the preform mold to form the preform; and
a preform separating operation of separating the molded preform from the preform mold.

6. The method of claim 5, further comprising: a bushing insertion operation of inserting some or all of bushings to be coupled to the knuckle for a vehicle into the recess formed in the preform mold between the preform-mold preparation operation and the material filling operation.

7. The method of claim 5, wherein, in the material filling operation, an amount of material required to form the main molding object is filled into the recess of the preform mold.

8. The method of claim 7, wherein the material filled into the recess of the preform mold to form the preform in the material filling operation is carbon chip material.

9. The method of claim 7, wherein the main-molding-object forming operation includes:
a main-molding-object-mold preparation operation of preparing a main-molding-object mold in which a recess having a shape corresponding to the shape of the main molding object is formed;
a preform insertion operation of inserting the preform into the recess of the main-molding-object mold;
a hot-pressing operation of hot-pressing the preform inserted into the recess of the main-molding-object mold to form the main molding object; and
a main-molding-object separating operation of separating the hot-pressed main molding object from the main-molding-object mold.

10. The method of claim 9, further comprising: after the main-molding-object forming operation, a post-processing and/or bushing coupling operation of performing subsequent processing necessary for the main molding object and/or coupling a bushing(s) necessary for the knuckle for a vehicle.
